(19) United States
(12) Patent Application Publication
(10) Pub. No.: US 2012/0239217 A1
(43) Pub. Date: Sep. 20, 2012

(54) ENERGY REDUCING APPARATUS

(75) Inventors: Toshimitsu Kumazawa, Kawasaki-shi (JP); Kazuto Kubota, Kawasaki-shi (JP); Shuichiro Imahara, Kawasaki-shi (JP); Yoshinori Kobayashi, Kawasaki-shi (JP)

(73) Assignee: KABUSHIKI KAISHA TOSHIBA, Tokyo (JP)

(21) Appl. No.: 13/426,928

(22) Filed: Mar. 22, 2012

Related U.S. Application Data
(63) Continuation of application No. PCT/JP2009/066567, filed on Sep. 24, 2009.

(51) Int. Cl. G05F 5/00

(52) U.S. Cl. 700/295

(57) ABSTRACT

An energy reducing apparatus includes: an input module through which to input a target energy consumption value; an acquiring module configured to acquire energy consumptions of plural apparatus every measurement period; a totaling module configured to calculate sums of energy consumptions of each of the apparatus in a prescribed period based on energy consumptions measured every measurement period; a calculating module configured to calculate a first index indicating a deviation between an average value of past energy consumptions and a current energy consumption based on energy consumptions measured every measurement period and the sums for each of the apparatus; and an allocating module configured to allocate an energy consumption to each of the apparatus so that the energy consumption value is satisfied by preferentially reducing the energy consumption of an apparatus whose first index is small.

### CROSS-REFERENCE TO RELATED APPLICATION(S)

This is a Continuation Application of PCT Application No. PCT/JP2009/066567, filed on Sep. 24, 2009, which was published under PCT Article 21(2) in Japanese, the entire contents of which are incorporated herein by reference.

### FIELD

The present invention relates to an energy reducing apparatus.

### BACKGROUND

As for the apparatus control and information presentation methods for attaining a target value of an energy consumption such as power, electric energy, an electricity charge, or an environmental load, a related art discloses a method of controlling a particular apparatus by calculating a target value per unit time from a set target value.

### BRIEF DESCRIPTION OF THE DRAWINGS

A general architecture that implements the various features of the present invention will now be described with reference to the drawings. The drawings and the associated descriptions are provided to illustrate embodiments and not to limit the scope of the present invention.

FIG. 1 is a block diagram showing the configuration of an energy reducing apparatus according to a first embodiment of the present invention.

FIG. 2 shows energy consumptions of an apparatus measured every prescribed interval.

FIGS. 3A and 3B show sums of energy consumptions in an evaluation unit period and a calculated frequency distribution of energy consumptions.

FIG. 4 is a flowchart of a process which is executed in the first embodiment.

FIG. 5A is a block diagram showing the configuration of an energy reducing apparatus according to a second embodiment of the invention.

FIG. 5B shows operation states, energy consumptions, and power consumptions of an apparatus measured every prescribed interval.

FIGS. 6A to 6C show average power consumptions calculated in an evaluation unit and calculated frequency distributions of average power consumptions and use times.

FIG. 7 is a flowchart of a process which is executed in the second embodiment.

FIG. 8A is a block diagram showing the configuration of an energy reducing apparatus according to a third embodiment of the invention.

FIG. 8B shows operation states, energy consumptions, power consumptions, etc. of an apparatus measured every prescribed interval.

FIGS. 9A to 9D show relationships between the setting value of an apparatus and the use time and the average power consumption of the apparatus.

FIGS. 10A to 10D show relationships between the setting value of an apparatus and the use time and, the average power consumption of the apparatus.

FIG. 11 is a flowchart of a process which is executed in the third embodiment.

### DETAILED DESCRIPTION

Embodiments of the present invention will be hereinafter described with reference to the drawings. The same reference symbol denotes the same or similar items in the drawings to be referred to below, and redundant descriptions will be avoided.

The invention is directed to an energy reducing apparatus which performs calculation to determine the energy consumptions of what apparatus (TV receiver, air conditioner, illumination lamps, etc.) should be reduced to what extent to attain a target energy consumption value while minimizing reduction in the comfort of users (family members) in a living space of one home, for example.

### Embodiment 1

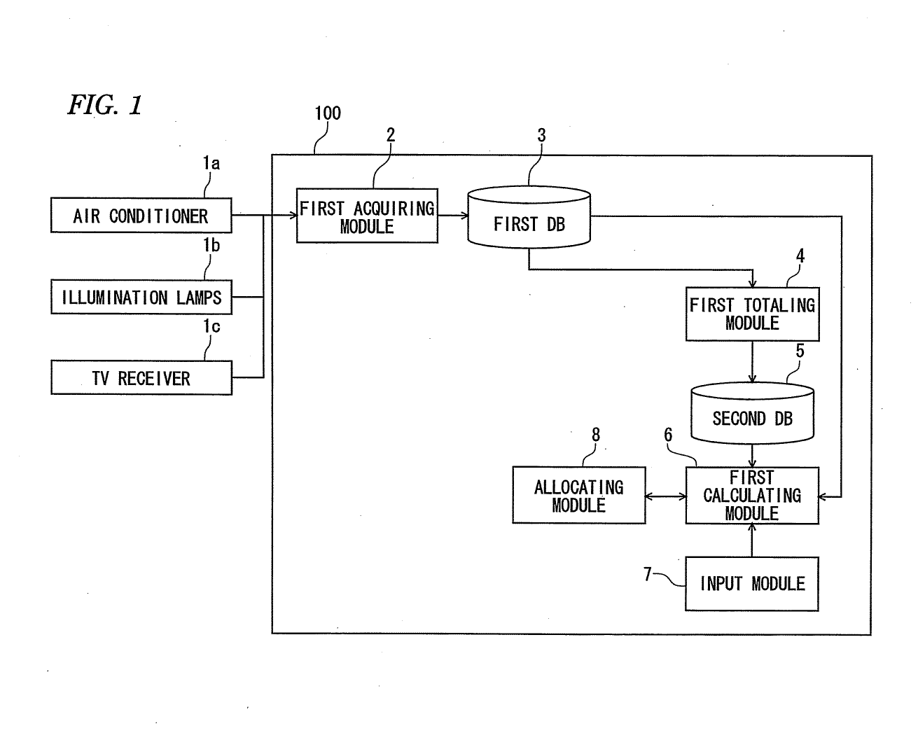

FIG. 1 is a block diagram of an energy reducing apparatus 100 according to a first embodiment of the invention.

The energy reducing apparatus 100 is equipped with a first acquiring module 2 for acquiring energy consumptions of plural apparatus connected to the energy reducing apparatus 100 every measurement period, a first DB (database) 3 for storing energy consumptions acquired by the first acquiring module 2, a first totaling module 4 for calculating the sums of electric energy consumptions of each apparatus (stored in the first DB 3) in a prescribed evaluation unit period, a second DB 5 for storing the sums, calculated by the first totaling module 4, of energy consumptions of each apparatus, a first calculating module 6 for calculating a deviation of each apparatus on the basis of energy consumptions stored in the first DB 3 and the sums of its energy consumptions stored in the second DB 5, an input module 7 through which the user inputs a target energy consumption value of all the apparatus to the first calculating module 6, and an allocating module 8 for allocating an energy consumption reduction amount to each apparatus on the basis of the deviation calculated by the first calculating module 6.

The term “apparatus” means apparatus such as an air conditioner 1a, illumination lamps 1b, and a TV receiver 1c that are connected to the energy reducing apparatus 100. In this embodiment, the deviation is an index indicating to what extent a current energy consumption of an apparatus deviates from an average value of past energy consumptions of the apparatus. The term “past” means a period of one month, one year, or the like.

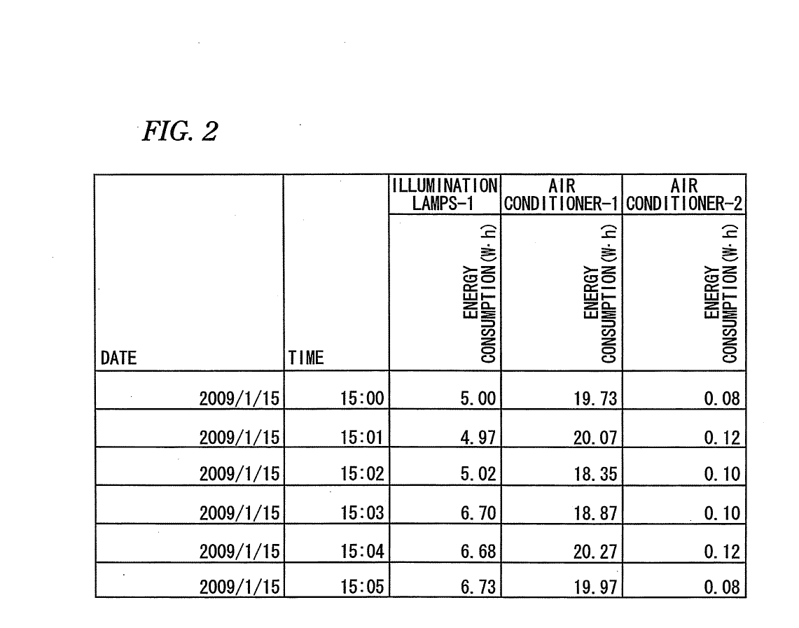

The first acquiring module 2 acquires energy consumptions of the plural apparatus connected to the energy reducing apparatus 100 every prescribed measurement interval (e.g., every minute) and stores measured energy consumptions in the first DB 3. For example, energy consumptions of each apparatus such as the illumination lamps 1b, the air conditioner 1a, or the like are stored in the first DB 3 in a manner shown in FIG. 2. In FIG. 2, energy consumptions in a state that the air conditioner 1a is in use are contained in the column “air conditioner-1” and energy consumptions in a state that the air conditioner 1a is not in use are contained in the column “air conditioner-2.”

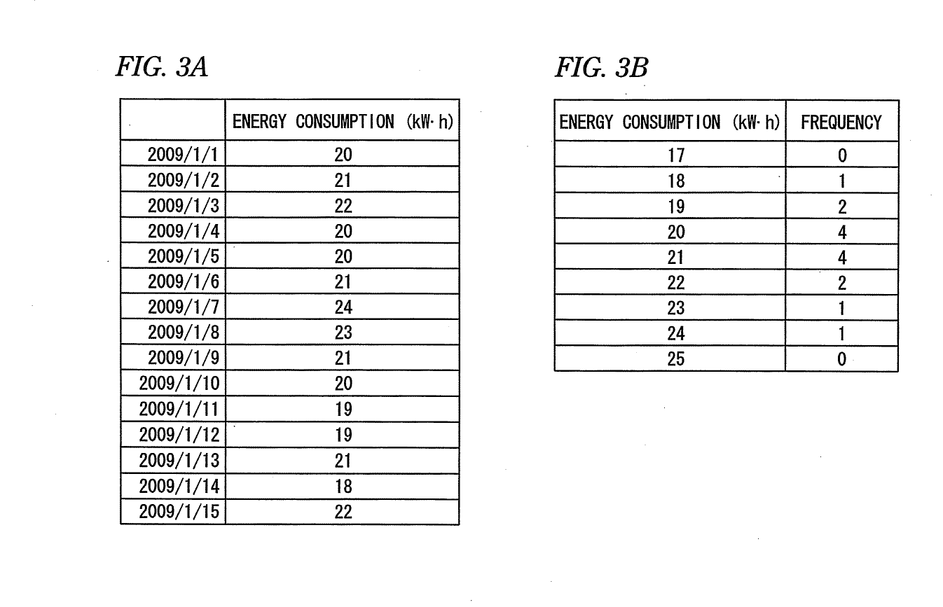

The first totaling module 4 stores, in the second DB 5, the sums of energy consumptions of each apparatus stored in the first DB 3. More specifically, the first totaling module 4 totals electric energy consumptions of individual measurement intervals (e.g., one minute) of each apparatus (stored in the first DB 3) every prescribed evaluation unit period (e.g., every day) and thereby calculates the sum of energy consumptions of each apparatus in each evaluation unit period (see FIG. 3A). Furthermore, as shown in FIG. 3B, the first totaling module 4 calculates a frequency distribution, that is, calculates the number of times of occurrence (frequency) of each sum value of energy consumptions of each apparatus. For example, where the evaluation unit period is one day, the first totaling module 4 calculates the number of days in each of which electric energy of 20 kWh was consumed, among 15 days.

Instead of using frequencies, a probability distribution may be calculated by using ratios obtained by dividing frequencies of respective classes (sums of energy consumptions) by the frequency of all classes.

The first calculating module 6 calculates a deviation on the basis of sums of energy consumptions in a prescribed period stored in the first DB 3 and sums of energy consumptions of each apparatus stored in the second DB 5.

A deviation calculation method will be described below. Although two or more apparatus are connected to the energy reducing apparatus 100 according to the embodiment, for the convenience of description the deviation calculation method will be described with an assumption that only one apparatus is connected to it.

First, the first calculating module 6 calculates an average value of past energy consumptions (obtained from the first DB 3) in a period (hereinafter referred to as a reference period) as a comparison reference for evaluation of an energy consumption such as the last week, the last month, or the same month in the past.

The average value Mᵢ of energy consumptions of an apparatus i (i denotes an apparatus kind) in the reference period can be calculated according to the following Equation 1:

$$\begin{matrix}[ Formula 1 ] & \\ {M}_{i} = \frac{{\sum }_{j ∈ ( reference period )} {w}_{j}}{the number of evaluation units in reference period} & Eq . 1\end{matrix}$$

where j is the evaluation unit period (j is a positive integer indicating a unit time such as one minute, hour, day, month, or year) and wⱼ is the power consumption in the time unit j.

Equation 1 will be explained below using the example of FIG. 3A (i denotes the air conditioner). Where the reference period is seven days from 2009 Jan. 9 to 2009 Jan. 15, an average value of energy consumptions of the air conditioner in the reference period is calculated as 20 kW·h by the following Equation 2:

$$\begin{matrix}[ Formula 2 ] & \\ {M}_{air conditioner} = \frac{21 + 20 + 19 + 19 + 21 + 18 + 22}{7} = 20 & Eq . 2\end{matrix}$$

Then, the first calculating module 6 calculates, using a frequency distribution of energy consumptions stored in the second DB 5, an average value m of energy consumptions that were used for calculation of a frequency distribution as a whole. The average value m of energy consumptions that were used for calculation of a frequency distribution as a whole can be calculated according to the following Equation 3:

$$\begin{matrix}[ Formula 3 ] & \\ m = \frac{\sum s \cdot {f}_{s}}{{\sum }_{s} {f}_{s}} & Eq . 3\end{matrix}$$

where fₛ is the frequency of the power consumption s kW·h.

Equation 2 will be explained below using the example of FIG. 3B. An average value m of energy consumptions that were used for calculation of a frequency distribution as a whole can be calculated as 20.7 kW·h by the following Equation 4.

$$\begin{matrix}[ Formula 5 ] & \\ {D}_{i} = \{ \begin{matrix}- {\sum }_{m < s \leq {M}_{i}} {f}_{s} … ( m < {M}_{i} ) \\ 0 … ( m = {M}_{i} ) \\ {\sum }_{{M}_{i} \leq s < m} {f}_{s} … ( m > {M}_{i} )\end{matrix} & Eq . 5\end{matrix}$$

A deviation D of the apparatus i can be calculated according to the following Equation 5:

$$\begin{matrix}[ Formula 4 ] & \\ m = \frac{\begin{matrix}17 \cdot 0 + 18 \cdot 1 + 19 \cdot 2 + 20 \cdot 4 + 21 \cdot \\ 4 + 22 \cdot 2 + 23 \cdot 1 + 24 \cdot 1 + 25 \cdot 0\end{matrix}}{0 + 1 + 2 + 4 + 4 + 2 + 1 + 1 + 0} = 20.7 & Eq . 4\end{matrix}$$

For example, the average value Mᵢ of the energy consumptions in the reference period is calculated as 20 kW·h by Equation 2 and the average value m of the energy consumptions that were used for calculation of the entire frequency distribution is calculated as 20.7 kW·h by Equation 4, that is, a relationship m<Mᵢ holds. Therefore, the sum of frequencies of energy consumptions that are larger than or equal to 20 kW·h and smaller than 20.7 kW·h (the frequency of 20 kW·h) is equal to 4, that is, a deviation Dᵢ is calculated as 4 when the frequency distribution of FIG. 3B is used. A deviation of each apparatus connected to the energy reducing apparatus 100 is calculated in this manner.

The allocating module 8 compares the deviations of the respective apparatus calculated in the reference period by the first calculating module 6, and repeats processing of preferentially reducing the energy consumption of an apparatus having a smallest deviation until a target energy consumption value of all the apparatus that was set by the user in advance through the input module 7 is attained. If the target value is attained, the allocating module 8 displays how energy consumptions will be allocated to the respective apparatus on a display module (not shown) that is connected externally or internally to the energy reducing apparatus 100. Since an energy consumption is the product of a power consumption and a time, the power consumption may be displayed by dividing the energy consumption by the time.

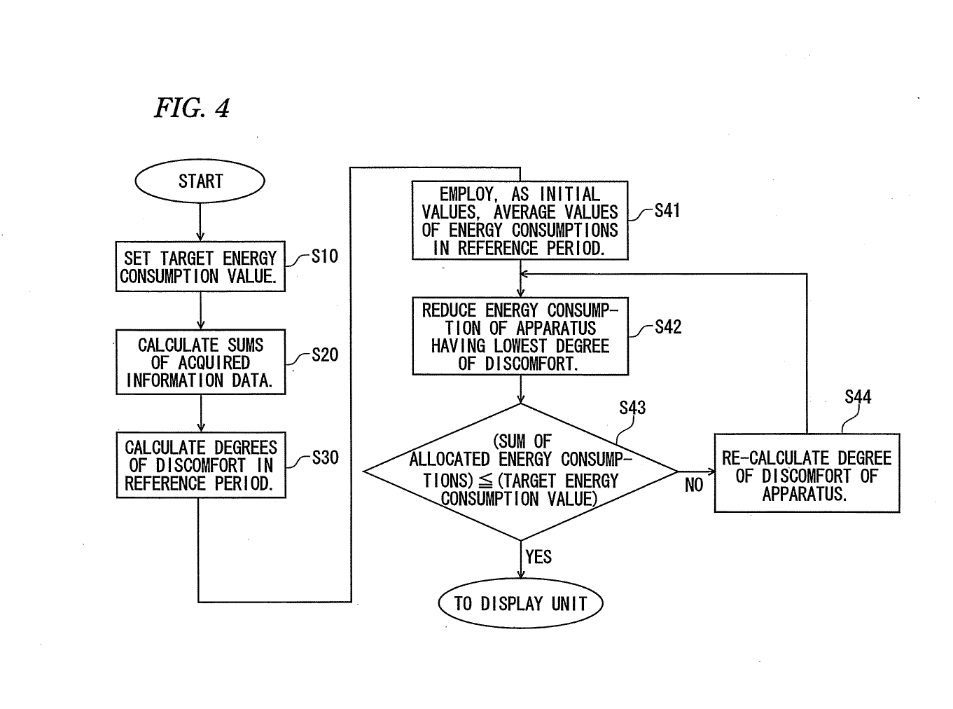

FIG. 4 is a flowchart of a process which is executed by the energy reducing apparatus 100.

At step S10, the user inputs a target energy consumption value through the input module 7 and sets it. Input items are three items, that is, a “reference period,” a “user target energy consumption value of all the apparatus,” and a “period (hereinafter referred to as an evaluation period) during which to attain the target energy consumption value of all the apparatus that is input by the user through the input module 7.”

For example, it is set that the energy consumption is 140 kW·h, the reference period is the seven days of the last week, and the evaluation period is the seven days of the next week. Although these items are basically input by the user, only part of the items may be input and values that were specified in advance may be used for the other item(s).

Although the items to be input through the input module 7 are basically the above-mentioned three items, each of the three items may be shown to the user. For example, since an electricity charge according to an energy consumption is to be paid, the item “user target energy consumption value of all the apparatus” may be replaced by an “user target electricity charge.” Furthermore, since an energy consumption relates to a CO₂ emission amount, the item “user target energy consumption value of all the apparatus” may be replaced by a “user target CO₂ emission amount.”

At step S20, the first totaling module 4 calculates the sum of energy consumptions of each apparatus stored in the first DB 3 and stores the calculated sums of energy consumptions in the second DB 5.

At step S30, the first calculating module 6 calculates a deviation of energy consumptions in the reference period for each apparatus on the basis of sums of energy consumptions in a prescribed period stored in the first DB 3 and sums of energy consumptions of each apparatus stored in the second DB 5.

At step S41, the allocating module 8 employs, as initial values, respective average values of energy consumptions in the reference period.

At step S42, the allocating module 8 reduces the energy consumption of an apparatus having a smallest deviation among the deviations calculated by the first calculating module 6 at step S42 from the average value of energy consumptions in the reference period that was set at step S41. The reduction of the energy consumption is 1 W·h, for example.

At step S43, the first calculating module 6 compares the sum of energy consumptions allocated to all the apparatus connected to the energy reducing apparatus 100 with the energy consumption value of all the apparatus that is set in the input module 7. If the sum of energy consumptions allocated to all the apparatus connected to the energy reducing apparatus 100 is larger than the energy consumption value of all the apparatus that is set in the input module 7 (S43: no), the process moves to step S44. If the sum of energy consumptions allocated to all the apparatus connected to the energy reducing apparatus 100 is smaller than or equal to the energy consumption value of all the apparatus that is set in the input module 7 (S43: yes), the energy consumptions allocated to the respective apparatus on the display module.

At step S44, the first calculating module 6 re-calculates a deviation of the apparatus whose energy consumption was reduced by the allocating module 8. Then, the process returns to step S42.

As described above, the energy consumptions of respective apparatus are reduced (new energy consumptions are allocated) in ascending order of the deviation starting from the smallest deviation until the sum of energy consumptions allocated to the apparatus connected to the energy reducing apparatus 100 becomes smaller than or equal to the energy consumption value that was set through the input module 7. Alternatively, the energy consumptions of respective apparatus may be reduced (new energy consumptions may be allocated) in ascending order of the deviation variation.

This embodiment makes it possible to provide the energy reducing apparatus 100 which can attain a set energy consumption value without causing reduction in comfort. This makes it possible to support energy saving that does not cause reduction in comfort.

### Embodiment 2

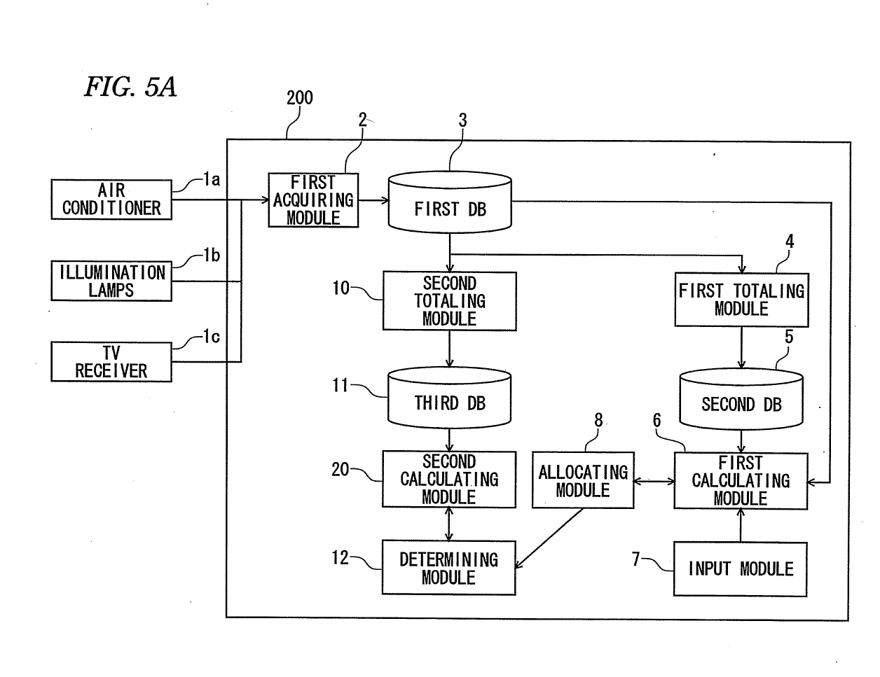

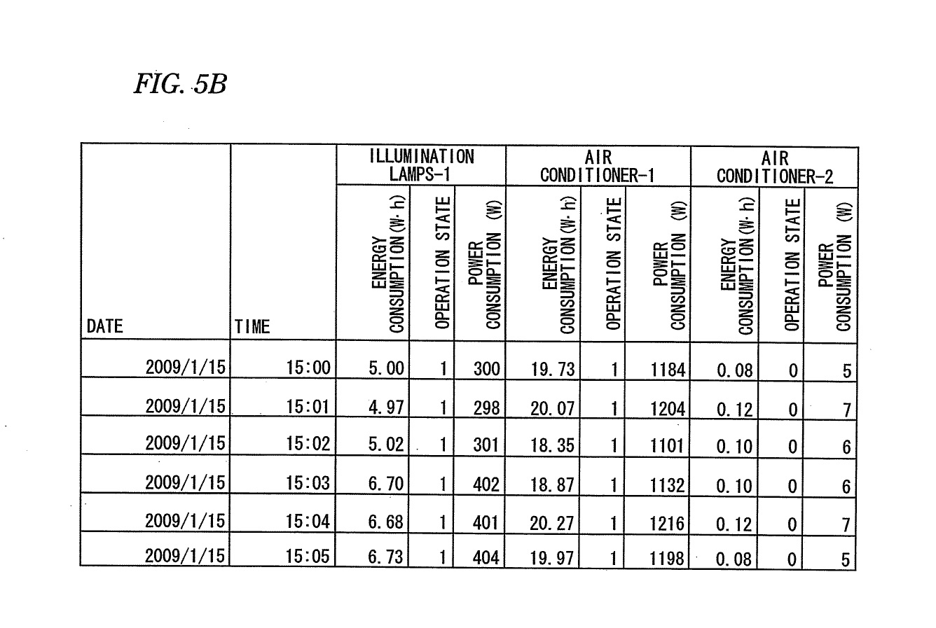

FIG. 5A is a block diagram of an energy reducing apparatus 200 according to a second embodiment of the invention. The energy reducing apparatus 200 is different from the energy reducing apparatus 100 in being further equipped with a second totaling module 10 for calculating the sum of use times and an average power consumption of each apparatus, a third DE 11 for storing the sum of use times and the average power consumption of each apparatus calculated by the second totaling module 10, a second calculating module 20 for calculating deviations of the use time and the average power consumption, and a first determining module 12 for determining which of the use time and the average power consumption should be reduced for an energy consumption allocated to each apparatus by the allocating module 8.

In this embodiment, the deviation is an index indicating to what extent a current use time or power consumption of an apparatus deviates from a past average use time or power consumption of the apparatus. The term “past” means a period of one month, one year, or the like.

Components of the energy reducing apparatus 200 that have the same or similar components in the energy reducing apparatus 100 will not be described below.

The first acquiring module 2 acquires, in addition to an energy consumption, a use time and a power consumption of each apparatus externally connected to the energy reducing apparatus 200 every prescribed measurement interval (e.g., every minute), and stores them in the first DB 3. As shown in FIG. 5B, a use time is acquired by detecting whether the operation state is “on” or “off.” More specifically, operation states “on” and “off” are represented by “1” and “0,” respectively and an operation state is detected every minute. An on time and an off time can be acquired by counting the numbers of 1s and 0s.

For example, operation states and power consumptions of such apparatus as the illumination lamps 1a and the air conditioner 1a are stored in the first DB 3 in a manner shown in FIG. 5B.

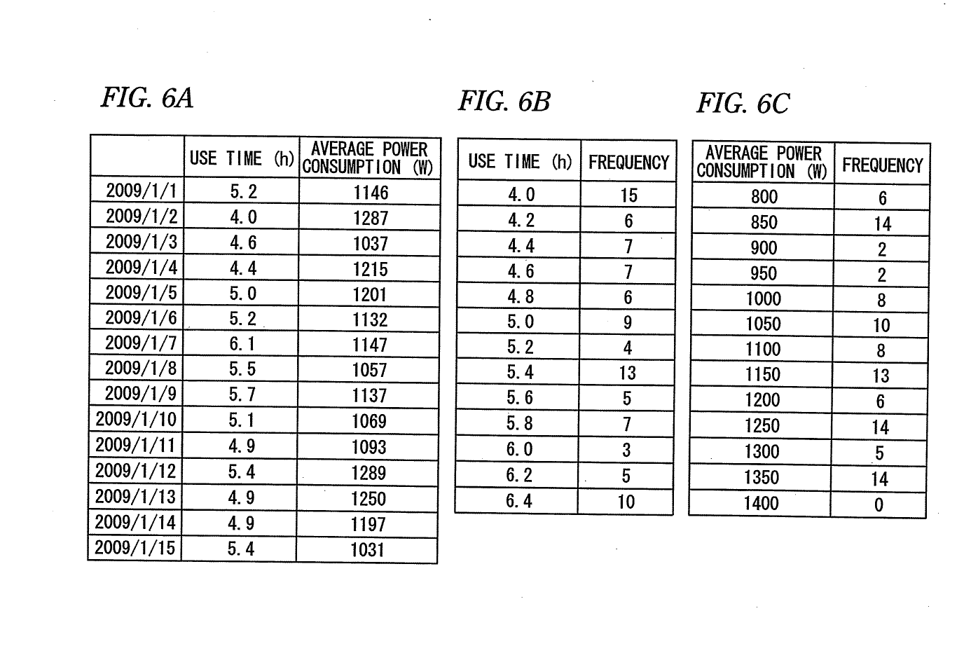

The second totaling module 10, which is connected to the first DB 3, stores the sum of use times and an average power consumption of each apparatus in the third DB 11. More specifically, like the first totaling module 4, the second totaling module 10 totals or averages, every evaluation unit interval (e.g., every day), data that were recorded in the first DB 3 at measurement intervals (e.g., one minute) and thereby calculates the sum of use times and an average power consumption every evaluation unit period as shown in FIG. 6A. As for the use time, the second totaling module 10 calculates a frequency distribution, that is, calculates the number of times of occurrence (frequency) of each use time numerical value in a manner shown in FIG. 6B. Likewise, as for the average power consumption, the second totaling module 10 calculates a frequency distribution, that is, calculates the number of times of occurrence (frequency) of each average power consumption numerical value in a manner shown in FIG. 6C.

For example, where the evaluation unit period is one day, the second totaling module 10 calculates the number of days in each of which the use time was 5 hours or the average power consumption was 1,000 W, among 15 days. What is calculated for each class of the use time or the average power consumption is not limited to the frequency; a probability distribution may be calculated by using ratios obtained by dividing frequencies of respective classes by the frequency of all classes.

The second calculating module 20 calculates deviations of the use time and the average power consumption of each apparatus. The calculation methods of deviations of the use time and the average power consumption are same as the calculation method employed by the first calculating module 6 and hence will not be described below.

The determining module 12 determines which of the use time and the average power consumption should be reduced to attain an energy consumption allocated by the allocating module 8, and displays a determination result on the display module (not shown) that is connected externally or internally to the energy reducing apparatus 200. Since each of the use time and the average power consumption is represented by the deviation, one, having a smaller deviation, of the use time and the average power consumption is employed as a subject of reduction. That is, one, having a smaller deviation, of the use time and the average power consumption is reduced until the energy consumption which is the product of the use time and the average power consumption becomes smaller than or equal to an allocated energy consumption, whereby a use time and an average power consumption for attaining the allocated energy consumption are determined.

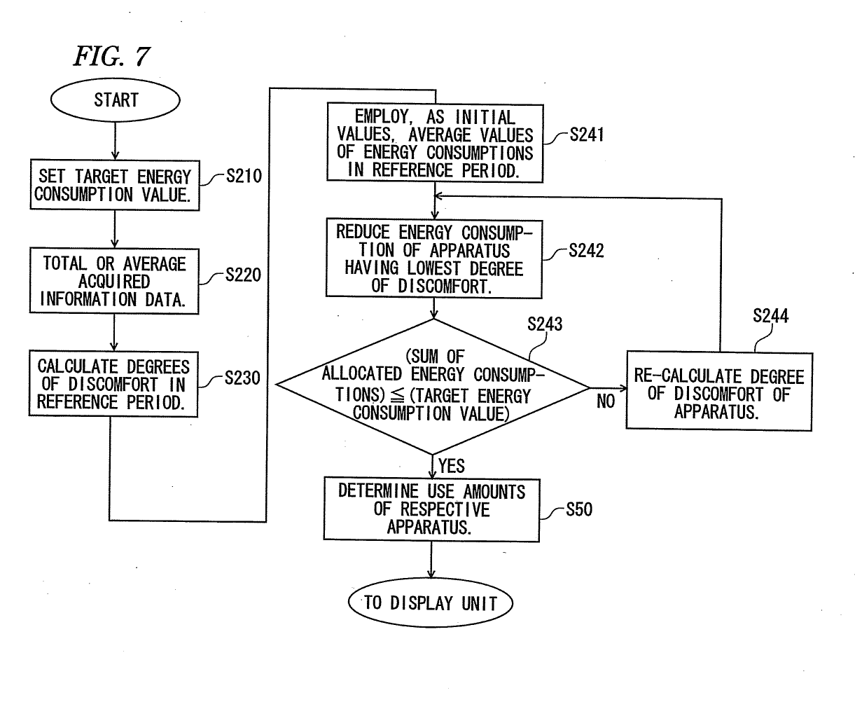

FIG. 7 is a flowchart of a process which is executed by the energy reducing apparatus 200.

In the energy reducing apparatus 200, steps S210, S220, S230, and S241-S244 are the same as steps S10, S20, S30, and S41-S44 shown in FIG. 4, respectively and hence will not be described below.

At step S50, the second calculating module 20 calculates deviations of the use time and the average power consumption of each apparatus in the reference period. A use time and an average power consumption for attaining an allocated energy consumption are determined on the basis of the calculated deviations, and results are displayed on the display module (not shown) that is connected externally or internally to the energy reducing apparatus 200.

In this embodiment, to attain a target energy consumption value that is input by the user through the input module 7, the two parameters which are different in unit, that is, the use time and the average power consumption, can be compared with each other using the common index of deviation. Therefore, a use time and an average power consumption of each apparatus having a small deviation can be presented to the user. That is, energy saving can be realized more easily by showing how to use apparatus in a specific manner instead of showing only energy consumptions as in the first embodiment.

### Embodiment 3

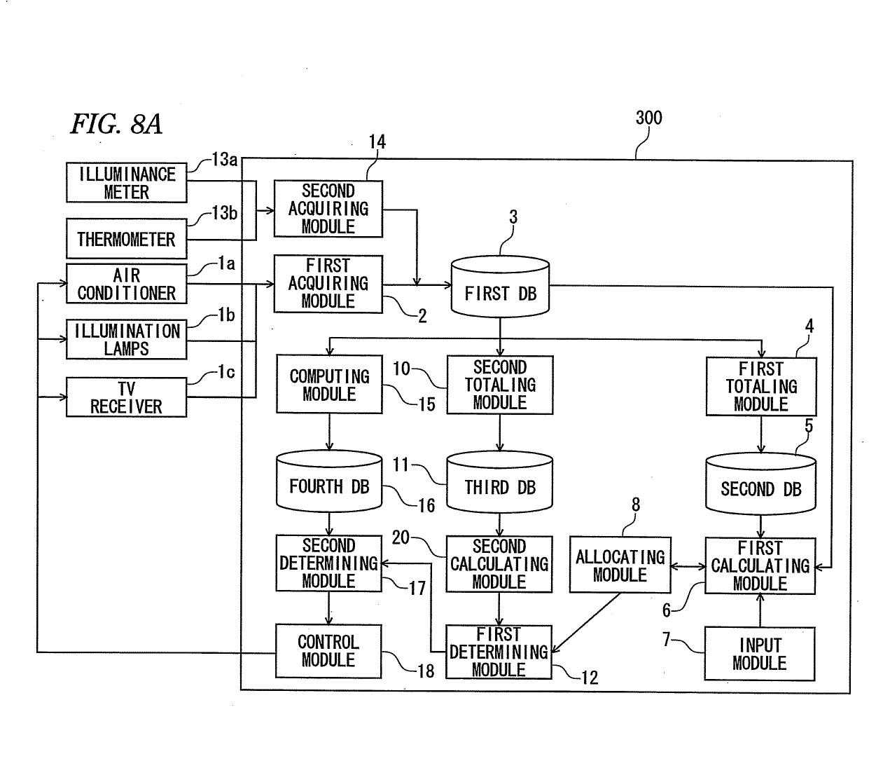

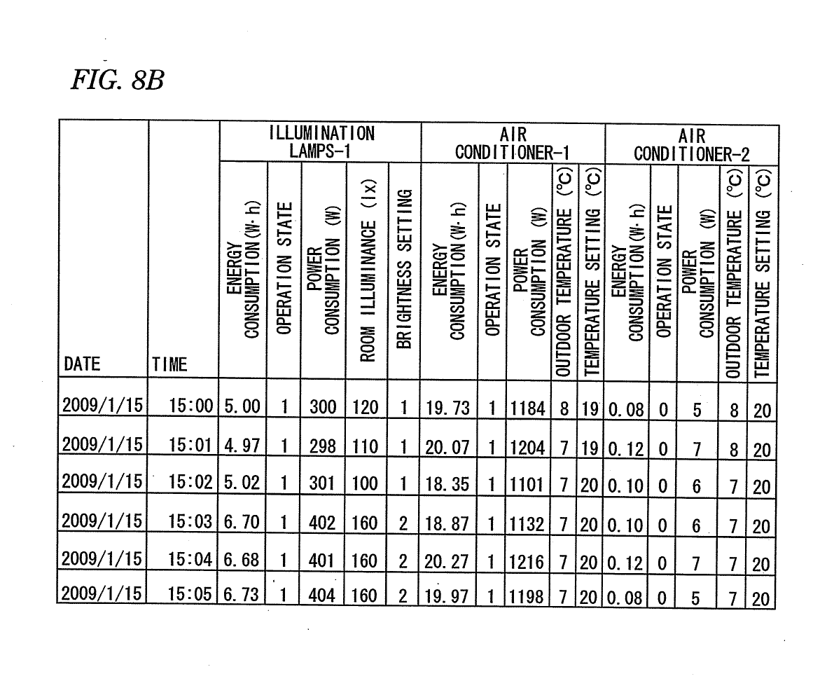

FIG. 8A is a block diagram of an energy reducing apparatus 300 according to a third embodiment of the invention. The energy reducing apparatus 300 is different from the energy reducing apparatus 200 in being further equipped with a second acquiring module 14 for acquiring environment information (illuminance and air temperature) while the apparatus are in operation, a computing module 15 for calculating an average illuminance and an average temperature of a state that the apparatus were in operation and calculates an average apparatus-in-operation temperature for each use time and an average apparatus-in-operation temperature setting value for each average power consumption, a fourth DB 16 for storing the average apparatus-in-operation temperature for each use time and an average apparatus-in-operation temperature setting value for each average power consumption calculated by the computing module 15, a second determining module 17 for determining whether to control the control subject apparatus, and a control module 18 for controlling the apparatus such as the air-conditioner 1a, the illumination lamps 1b, and the TV receiver 1c that are connected to the energy reducing apparatus 300. An illuminance can be measured by an illuminance meter 13a that is externally connected to the energy reducing apparatus 300, and an air temperature can be measured by a thermometer 13b that is externally connected to the energy reducing apparatus 300.

Components of the energy reducing apparatus 300 that have the same or similar components in the energy reducing apparatus 100 or 200 will not be described below.

The first acquiring module 2 further acquires setting values of the respective apparatus that are externally connected to the energy reducing apparatus 300, and sends acquired data to the first DB 3. The setting values are mainly ones that directly influence the power consumptions, such as the setting temperature of the air conditioner 1a and the brightness setting of the illumination lamps 1b.

The second acquiring module 14 is connected to measuring devices such as the illuminance meter 13a and the thermometer 13b, and stores environment information such as an illuminance and a temperature in the first DB 3. For example, illuminances, brightness setting values of the illumination lamps 1b, air temperatures, and temperature setting values of the air conditioner 1a are stored in the first DB 3 in a manner shown in FIG. 8B. In FIG. 8B, a brightness setting “1” means that the illuminance of the illumination lamps 1b is low and a brightness setting “2” means that the illuminance of the illumination lamps 1b is high.

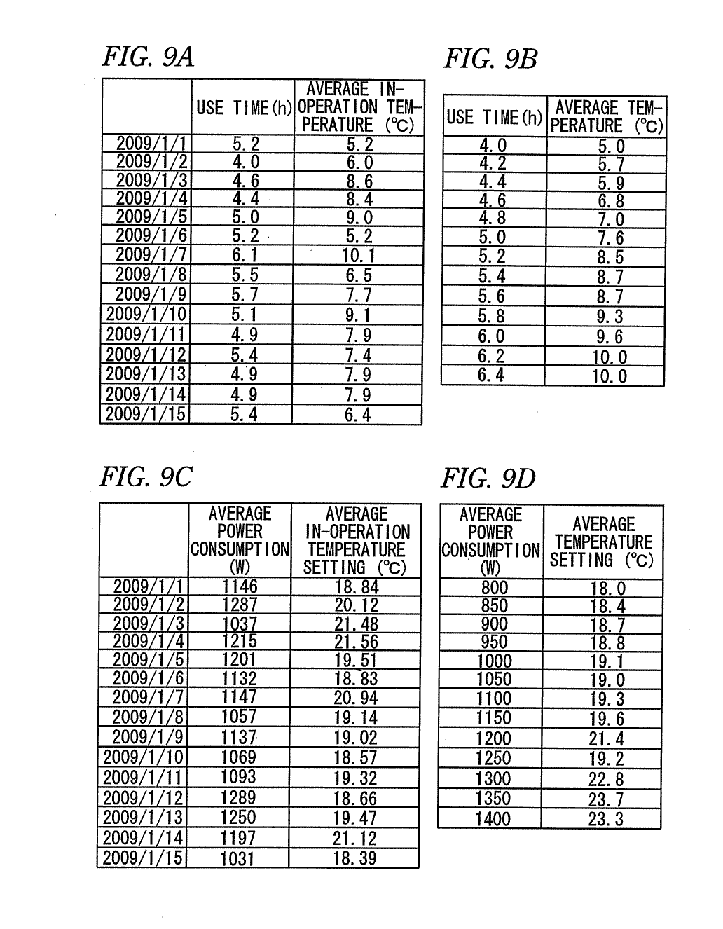

Like the second totaling module 10, the computing module 15 averages, every evaluation unit interval (e.g., every day), data that were recorded in the first DB 3 at measurement intervals (e.g., one minute). For example, where the apparatus that is externally connected to the energy reducing apparatus 300 is the air conditioner 1a, the computing module 15 calculates an average temperature of a state that the apparatus externally connected to the energy reducing apparatus 300 was in operation for a use time of each evaluation unit period and an average temperature setting value of a state that the apparatus externally connected to the energy reducing apparatus 300 was in operation for each average power consumption in manners shown in FIGS. 9A and 9C.

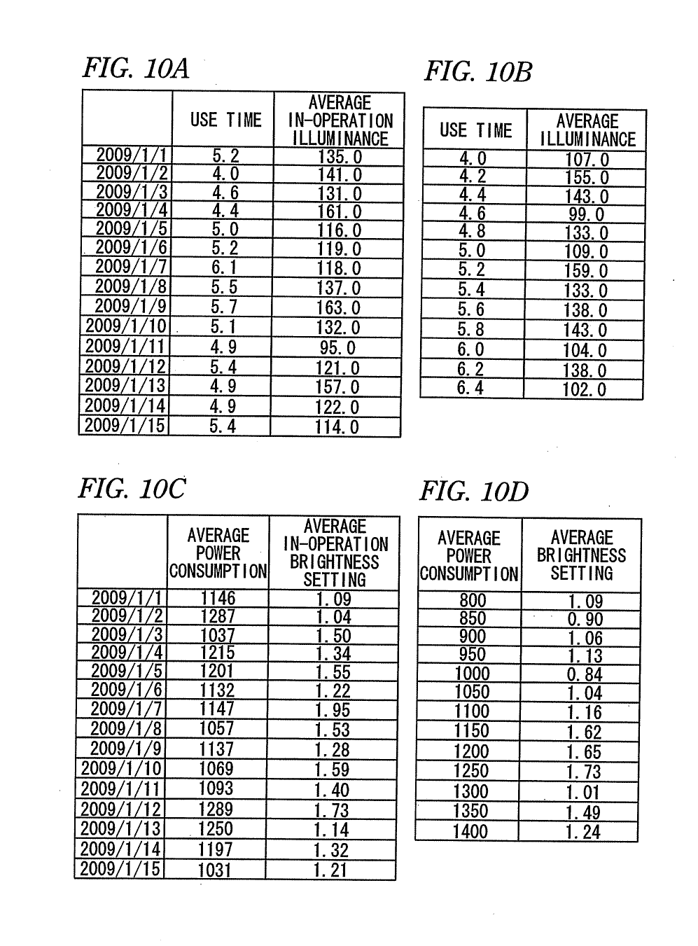

In the case of the illumination lamps 1b, the computing module 15 calculates an average illuminance of a state that the apparatus externally connected to the energy reducing apparatus 300 was in operation for a use time of each evaluation unit period and an average brightness setting value of a state that the apparatus externally connected to the energy reducing apparatus 300 was in operation for each average power consumption in manners shown in FIGS. 10A and 10C.

Furthermore, on the basis of the calculated data, the computing module 15 calculates an average temperature for a certain use time (see FIG. 9B) and also calculates an average temperature setting value for a certain average power consumption (see FIG. 9D). Resulting average temperatures and average temperature setting values are stored in the fourth DB 16. The average temperatures shown in FIG. 98 indicate rough average temperatures below which the air conditioner 1a can be used in the case where the air conditioner 1a is in heating operation. For example, where the use time is four hours, the air conditioner 1a can be used if the air temperature is lower than or equal to 5° C. The average temperature setting values shown in FIG. 9D indicate approximate average power consumptions that are required for attaining those average temperature setting values.

In the case of the illumination lamps, the computing module likewise calculates average illuminances and average brightness setting values instead of average temperatures and average temperature setting values that are calculated in the case of the air conditioner. In this case, average illuminances indicate rough average illuminances below which the illumination lamps can be used. The average brightness setting values approximate average power consumptions that are required for attaining those average brightness setting values. In this case, structures shown in FIGS. 10A to 10D are employed.

The second determining module 17 sets values for a control for attaining a use time and an average power consumption of a control subject apparatus determined by the first determining module 12. For example, where the control subject apparatus is the air conditioner 1a, the second determining module 17 determines an air temperature below which the air conditioner 1a should be operated on the basis of the use times and the average temperatures of the air conditioner 1a (see FIG. 9B) and also determines a setting temperature at which the air conditioner 1a should be operated on the basis of the average power consumptions and the temperature setting values of the air conditioner 1a (see FIG. 9D). More specifically, if the first determining module 12 determines that the use time and the average power consumption of the air conditioner 1a should be 5 hours and 800 W, respectively, it is seen from FIGS. 9B and 9D that the air conditioner 1a can be operated with an energy consumption allocated by the allocating module 8 if the air conditioner 1a is turned on when the air temperature is lower than or equal to 7.6° C. and the temperature setting value of the air conditioner 1a is 18° C. or lower.

The control module 18 controls the control subject apparatus that is externally connected to the energy reducing apparatus 300 on the basis of the values determined by the second determining module 17.

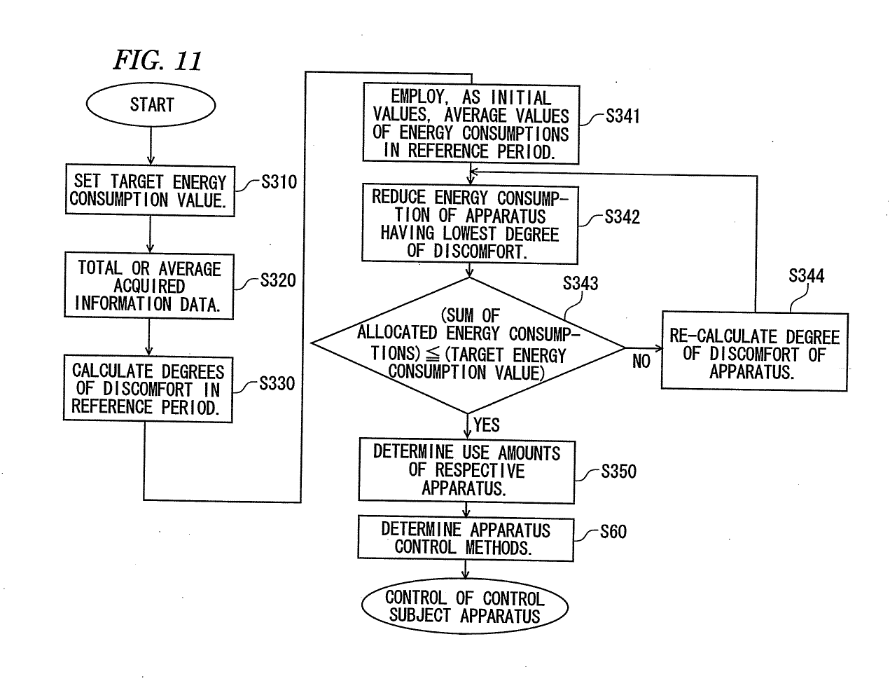

FIG. 11 is a flowchart of a process which is executed by the energy reducing apparatus 300.

In the energy reducing apparatus 300, steps S310, S320, S330, S341-S344, and S350 are the same as steps S210, S220, S230, S241-S244, and S50 shown in FIG. 7, respectively and hence will not be described below. In the following, it is assumed that the energy reducing apparatus 300 controls the air conditioner 1a.

At step S60, the second determining module 17 determines values for a control for attaining a use time and an average power consumption of a control subject apparatus determined by the first determining module 12.

Then, the control module 18 controls the control subject apparatus that is externally connected to the energy reducing apparatus 300 on the basis of the values determined by the second determining module 17.

This embodiment makes it possible to automatically operate an apparatus so as to attain a target energy consumption with small deviations by taking past use situations into consideration.

In each of the above-described embodiments, the first DB 3, the second DB 5, the third DB 11, and the fourth DB 16 may be implemented as a single memory.

The first acquiring module 2 and the second acquiring module 14 may be combined into a single acquiring module. The first totaling module 4 and the second totaling module 10 may be combined into a single totaling module. The first calculating module 6 and the second calculating module 20 may be combined into a single calculating module. The first determining module 12 and the second determining module 17 may be combined into a single determining module.

Furthermore, in each of the above-described embodiments, the energy reducing apparatus 100 may be configured by hardware or software. Where the energy reducing apparatus 100 configured by software, the energy reducing apparatus 100 may be configured in such a manner that various programs to be run by the energy reducing apparatus 100 are stored in a computer that is connected to a network such as the Internet and provided by downloading them over the network. Alternatively, these programs may be recorded on a computer-readable recording medium in the form of installable or executable files, whereby the energy reducing apparatus 100 is configured as a computer-readable recording medium which has the programs each including plural instructions that can be executed by a computer.

1. An energy reducing apparatus comprising:
an input module through which to input a target energy consumption value;
an acquiring module configured to acquire energy consumptions of plural apparatus every measurement period;
a totaling module configured to calculate sums of energy consumptions of each of the apparatus in a prescribed period based on energy consumptions measured every measurement period;
a calculating module configured to calculate a first index indicating a deviation between an average value of past energy consumptions and a current energy consumption based on energy consumptions measured every measurement period and the sums for each of the apparatus; and
an allocating module configured to allocate an energy consumption to each of the apparatus so that the energy consumption value is satisfied by preferentially reducing the energy consumption of an apparatus whose first index is small.

2. The energy reducing apparatus according to claim 1, further comprising
a determining module configured to determine reductions of an use time and an average power consumption so that an energy consumption allocated by the allocating module is satisfied with a higher priority given to one of the use time and the average power consumption, which has a smaller second index, wherein:
the acquiring module acquires the use time and the average power consumption;
the totaling module calculates sums of use times and average power consumptions based on use times and average power consumptions acquired by the acquiring module for each of the apparatus; and
the calculating module calculates a second index indicating deviations between average values of past use times and power consumptions and a current use time and average power consumption based on the use times and the average power consumptions calculated by the totaling module for each of the apparatus.

3. The energy reducing apparatus according to claim 2, further comprising:
a computing module; and
a control module configured to control the individual apparatus, wherein:
the acquiring module acquires a room temperature setting value and a brightness setting value of the respective apparatus, and an air temperature and an illuminance of a state that the respective apparatus are in operation;
the computing module calculates average air temperatures and average illuminances corresponding to respective use times and average setting values corresponding to respective average power consumptions of a state that the respective apparatus are in operation based on air temperatures, illuminances, average power consumptions, and room temperature setting values and brightness setting values of the respective apparatus acquired by the acquiring module;
the determining module determines values to be used for performing a control so that the use time and the average power consumption of the apparatus determined by the determining module are satisfied based on the average air temperatures and the average illuminances corresponding to the respective use times and the average setting values corresponding to the respective average power consumptions of a state that the respective apparatus are in operation calculated by the computing module; and
the control module controls the apparatus based on the values determined by the determining module.
